(19) United States
(12) Patent Application Publication
(10) Pub. No.: US 2007/0018964 A1
(43) Pub. Date: Jan. 25, 2007

(54) Portable device and method for interacting therewith

(75) Inventors: Billy G. Moon, Morrisville, NC (US); John A. Toebes, Cary, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/185,604

(22) Filed: Jul. 19, 2005

(51) Int. Cl. G09G 5/00

(52) U.S. Cl. 345/173

(57) ABSTRACT

A portable device includes a display that displays information from an application. A touchpad is oriented perpendicularly to the display. The touchpad detects one or more contact inputs. The one or more contact inputs associate with one or more virtual keys that the application interprets to display the information on the display. An inertial device detects one or more motion inputs. The one or more motion inputs associate with one or more virtual keys that the application interprets to display the information on the display.

### TECHNICAL FIELD OF THE INVENTION

This invention relates generally to the field of communications and more specifically to a portable device and method for interacting therewith.

### BACKGROUND

Traditionally, public safety officers, homeland security personnel, and military personnel use portable devices, such as radios, to interact with other officers, personnel, base stations, or other locations. The devices used in traditional applications include large keypads, knobs, and/or buttons for user interaction. The devices are worn by the user and include top mount displays. However, many of these portable devices are cumbersome to use and do not provide an extensive array of features to benefit users in public safety, homeland security, and military applications.

### SUMMARY OF THE DISCLOSURE

From the foregoing, it may be appreciated by those skilled in the art that a need has arisen for an improved portable device. In accordance with the present invention, disadvantages and problems associated with conventional portable devices may be reduced or eliminated.

According to one embodiment of the present invention, a portable device includes a display that displays information from an application. A touchpad is oriented perpendicularly to the display. The touchpad detects one or more contact inputs. The one or more contact inputs associate with one or more virtual keys that the application interprets to display the information on the display. An inertial device detects one or more motion inputs. The one or more motion inputs associate with one or more virtual keys that the application interprets to display the information on the display.

Certain embodiments of the invention may provide one or more technical advantages. A technical advantage of one embodiment includes providing a portable device that facilitates user interaction with minimal effort. The portable device enables intuitive user interactions. For example, the portable device includes a touchpad and guide bumps. As another example, portable device includes an inertial device to further facilitate intuitive user interactions.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, wherein like reference numerals represent like parts, in which:

FIG. 1 illustrates a system including a portable device;

FIG. 2 illustrates a detailed example of the portable device;

FIG. 3 is a flowchart that illustrates interacting with the portable device.

### DETAILED DESCRIPTION OF THE DRAWINGS

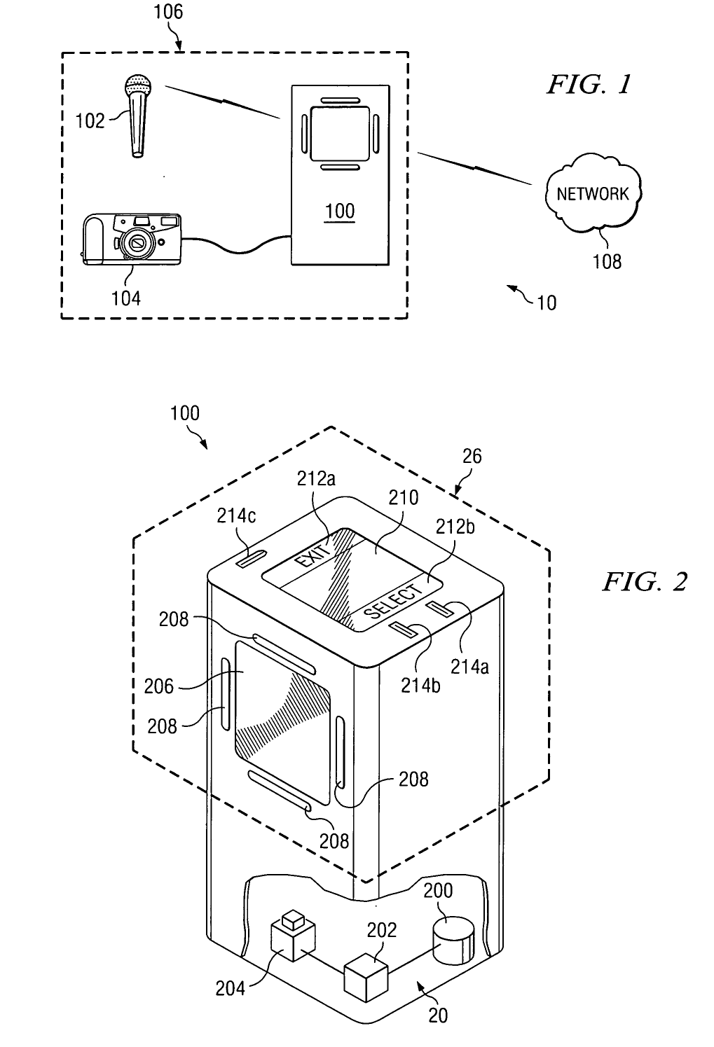

FIG. 1 illustrates a system 10 including a portable device 100. Portable device 100 may serve as a personal router within a communication environment. System 10 includes peripheral devices 102 and 104 that may be used in conjunction with portable device 100 within a wireless personal area network (WPAN) 106. Portable device 100 facilitates communication of peripheral devices 102 and 104 with network 108.

Portable device 100 routes traffic and facilitates communication for devices within WPAN 106. For example, portable device 100 routes traffic for peripheral devices 102 and 104 using any suitable communication technology, such as 802.11, 802.15, Code Division Multiple Access (CDMA), or General Packet Radio Service (GPRS). In an embodiment, portable device 100 facilitates user interaction with portable device 100 with minimum cognitive effort and minimum hand interaction. For example, portable device 100 may be worn on a belt clip or in a pouch. Portable device 100 may operate in different modes, which allows the user to interact with portable device 100 in several ways. For example, portable device 100 has a contact mode that recognizes contact inputs and a motion mode that recognizes motion inputs.

Peripheral devices 102 and 104 are any suitable devices that communicate within WPAN 106, such as a personal digital assistant (PDA), a pager, a cellular phone, a Global Positioning System (GPS) receiver, sensors, a scanner, or a magnetic card reader. In the illustrated embodiment, peripheral device 102 illustrates a wireless microphone and peripheral device 104 illustrates a camera.

Portable device 100 and peripheral devices 102 and 104 exist within Wireless Personal Area Network (WPAN) 106. WPAN 106 may connect peripheral devices 102 and 104 and portable device 100 within any suitable range of an individual user.

Network 108 facilitates communication of portable device 100 with other networks and devices. Network 108 may include a wireless local area network (WLAN), a wireless wide area network (WWAN), or any suitable wireless communication link, or any combination of the preceding. Network 108 may include any combination of gateways, routers, hubs, switches, access points, base stations, and any other hardware and/or software that may implement any suitable protocol or communication technology.

Modifications, additions, or omissions may be made to system 10. For example, in the illustrated embodiment, portable device 100 facilitates communication for peripheral devices 102 and 104. In another embodiment, portable device 100 may interact with any suitable number or any suitable kind of devices within WPAN 106. Additionally, system 10 may include any suitable number of WPANs 106 and networks 108. Any suitable logic comprising software, hardware, other logic, or any suitable combination of the preceding may perform the functions of system 10 and the elements within system 10.

FIG. 2 illustrates a detailed example of portable device 100. Portable device 100 includes control components 20 and interfaces 26. Control components 20 direct the operation of portable device 100. Interfaces 26 receive inputs from a user, a device, or other element and/or provide outputs to the user, the device, or other element.

Control components 20 include a memory 200, a processor 202, and an inertial device 204. Memory 200 stores, either permanently or temporarily, data, operational software, and other information for processor 202. Memory 200 includes any one or a combination of volatile or nonvolatile local or remote devices suitable for storing information. For example, memory 200 may include random access memory (RAM), read only memory (ROM), magnetic storage devices, or any other suitable information storage device or a combination of these devices.

Processor 202 controls the operation of portable device 100 by processing information received from interfaces 26 and memory 200. Processor 202 includes any hardware, software, or both that operate to control and process information. For example, processor 202 may be a programmable logic device, a microcontroller, a microprocessor, any suitable processing device, or any combination of the preceding.

Inertial device 204 detects and measures the movement of portable device 100. Inertial device 204 may include any hardware, software, or a combination of the preceding that detects and measures movement. Inertial device 204 may include an accelerometer, a geophone, a gyroscope, or any suitable inertial device or micro-electromechanical system. Inertial device 204 detects and measures the movement of portable device 100 in any suitable direction, rotation, or dimension. For example, inertial device 204 may include an accelerometer that detects and measures movement on three axes: right and left, forward and backward, and up and down. Because inertial device 204 detects and measures movement, the user may move portable device 100 to interact with it. Moving portable device 100 provides a motion input that inertial device 204 detects, which causes portable device 100 to generate a virtual key. The specific movements of portable device 100 may associate with specific virtual keys. For example, moving the portable device 100 up and down may associate with zooming in and zooming out of display 210.

According to the illustrated embodiment, interfaces 26 include components that communicate and interact with the user and other devices. Touchpad 206 senses the position of a user's fingers on its surface to generate a virtual key. Located parallel to the user, touchpad 206 may be used equally well by right-handed and left-handed users. Touchpad 206 may recognize any suitable contact input such as tapping, sliding, other contact input, or a combination of the preceding. Additionally, touchpad 206 may include specific regions that associate with specific virtual keys, or a type of contact input may associate with a specific virtual key. For example, tapping touchpad 206 on the left may generate a virtual key that causes a menu to open, while tapping in the middle of touchpad 206 may generate a virtual key that changes the mode of portable device 100.

Touchpad 206 also provides for safe user interaction. Touchpad 206 does not produce an electrical spark during operation, which is safer than knobs or buttons that produce an electrical spark. Therefore, users may use portable device 100 without the risk of creating an electrical spark. Touchpad 206 may include any suitable hardware, software, or a combination of the preceding that recognizes a contact input and associates the contact input with a virtual key for portable device 100 to generate.

Guide bumps 208 assist the user in locating touchpad 206 without having to view touchpad 206. Therefore, the user can focus on display 210 while operating touchpad 206. Guide bumps 208 may be grooves, indentations, bumps, or other suitable elevation or depression to provide guidance for the user. Guide bumps 208 may be made of the same material as portable device 100 or of a different material to further distinguish guide bumps 208. In the illustrated embodiment, guide bumps 208 are on four sides of touchpad 206 in the middle of each side of touchpad 206.

Display 210 provides outputs to the user in response to the virtual keys generated from the inputs. Display 210 is located perpendicularly to touchpad 206 on the top of portable device 100 and outputs information to the user. The orientation of display 210 facilitates the unique interaction a user has with portable device 100. Display 210 may include any hardware, software, or a combination of the preceding that provides and/or receives information. In the illustrated embodiment, display 210 includes two soft menus 212 on opposite sides that associate with touchpad 206 and inertial device 204. For example, the left side of touchpad 206 associates with soft menu 212a and the right side of touchpad 206 associates with soft menu 212b.

Device interfaces 214a, 214b, and 214c represent any port or connection, real or virtual, including any suitable hardware and/or software that allow devices to communicate with portable device 100. For example, peripheral device 104 may connect to device interface 214a using a Universal Serial Bus (USB). In the illustrated embodiment, device interfaces 214a and 214b represent USB ports and device interface 214c represents an Institute of Electrical and Electronics Engineering (IEEE) 1394 port. In another embodiment, device interfaces 214 may represent any suitable external bus that exchanges information between devices.

In operation, a user interacts with portable device 100 using two modes: a contact mode and/or a motion mode. In the contact mode, touchpad 206 detects contact inputs. While in contact mode, the user may use guide bumps 208 to locate a specific region of touchpad 206. Upon locating the region, the user provides a contact input to touchpad 206. For example, the user may tap on the left side of touchpad 206, which is associated with soft menu 212a. Upon receiving the contact input, portable device 100 generates a virtual key in response to the input. The virtual key associates with a command of a displayable component, which is in an application on portable device 100. The application interprets the command of the displayable component and proceeds as the application directs.

A user may interact similarly with portable device 100 in a motion mode to have additional virtual keys. Instead of receiving a contact input, portable device 100 receives a motion input as detected by inertial device 204. A user may activate inertial device 204 using touchpad 206. For example, a user may move portable device 100 to the left, inertial device 204 detects the motion, and the motion input associates with soft menu 212a. Upon receiving the motion input, portable device 100 generates a virtual key. The virtual key associates with a command of a displayable component. The intuitive motion input allows the user to focus on display 210 while interacting with portable device 100.

Modifications, additions, or omissions may be made to portable device 100. For example, portable device 100 may operate in other suitable modes in addition to the contact mode and motion mode, and may recognize inputs in addition to the contact input and the motion input. As another example, portable device 100 may include any suitable number of device interfaces 214.

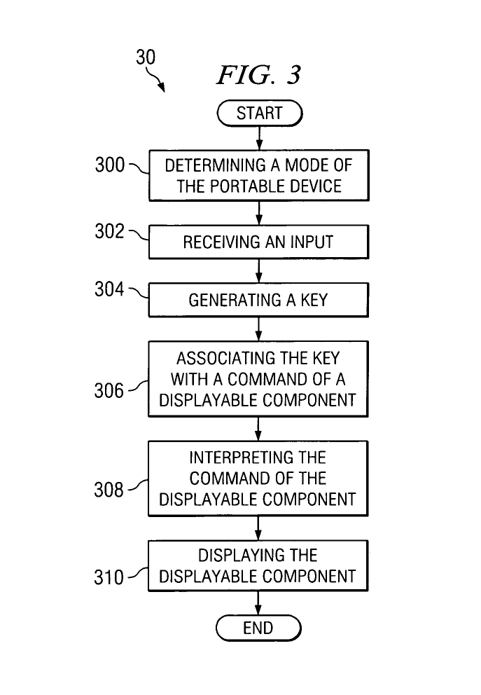

FIG. 3 is a flowchart 30 that illustrates interacting with portable device 100. At step 300, portable device 100 determines a mode of operation. For example, portable device 100 may operate in a contact mode or a motion mode. Portable device 100 receives an input associated with the mode at step 302. The input may be a contact input detected by touchpad 206 or a motion input detected by inertial device 204. From the input received, a virtual key is generated at step 304. Portable device 100 associates the virtual key with a command of a displayable component at step 306. An application on portable device 100 interprets the command of the displayable component at step 308. Portable device 100 may include one or more applications to interpret the commands. At step 310, portable device 100 displays the displayable component of the application on display 210.

Modifications, additions, or omissions may be made to the method. Additionally, steps may be performed in any suitable order.

While this disclosure has been described in terms of certain embodiments and generally associated methods, alterations and permutations of the embodiment and methods will be apparent to those skilled in the art. Accordingly, the above description of example embodiments does not constrain this disclosure. Other changes, substitutions, and alterations are also possible without departing from the scope and spirit of this disclosure.

What is claimed is:

1. A portable device, comprising:
a display operable to display information from an application;
a touchpad oriented perpendicularly to the display and operable to detect one or more contact inputs, wherein the one or more contact inputs associate with one or more virtual keys that the application interprets to display the information on the display; and
an inertial device operable to detect one or more motion inputs, wherein the one or more motion inputs associate with one or more virtual keys that the application interprets to display the information on the display.

2. The portable device of claim 1, wherein the inertial device includes an accelerometer operable to detect the one or more motion inputs.

3. The portable device of claim 2, wherein the accelerometer includes a three dimensional accelerometer operable to detect the one or more motion inputs on three axes.

4. The portable device of claim 1, further comprising guide bumps surrounding at least two sides of the touchpad and operable to assist in providing the one or more contact inputs on the touchpad.

5. The portable device of claim 1, wherein the display includes at least two soft menus that associate with the touchpad and the inertial device.

6. The portable device of claim 1, wherein the virtual key associates with a command of the application, the application is operable to perform panning and zooming operations.

7. The portable device of claim 1, further comprising one or more device interfaces operable to communicate with one or more devices within a personal area network.

8. A method for interacting with a portable device, comprising:
receiving one or more inputs, wherein the input is one or more contact inputs or one or more motion inputs;
generating one or more virtual keys based on the one or more inputs received;
associating the one or more virtual keys with a command of a displayable component;
interpreting the command of the displayable component in accordance with an application;
displaying the displayable component of the application, wherein displaying is perpendicular to the one or more contact inputs.

9. The method of claim 8, wherein receiving the one or more inputs includes receiving the one or more contact inputs on a touchpad.

10. The method of claim 9, wherein receiving the one or more contact inputs includes receiving a tapping input on a region of the touchpad, and receiving a sliding input on the region of the touchpad.

11. The method of claim 8, wherein receiving the one or more inputs includes receiving the one or more motion inputs as detected by an accelerometer.

12. The method of claim 8, further comprising:
determining an input mode of the portable device;
receiving a change input operable to toggle between a plurality of input devices that detects the one or more inputs.

13. The method of claim 12, wherein the input mode of the portable device includes a contact mode and a motion mode.

14. A system for interacting with a portable device, comprising:
means for receiving one or more inputs, wherein the one or more inputs include one or more contact inputs or one or more motion inputs;
means for generating one or more virtual keys based on the one or more inputs received;
means for associating the one or more virtual keys with a command of a displayable component;
means for interpreting the command of the displayable component in accordance with an application;
means for displaying the displayable component of the application, wherein displaying is perpendicular to the one or more contact inputs.

15. The system of claim 14, wherein means for receiving the one or more inputs includes receiving the one or more contact inputs on a touchpad.

16. The system of claim 15, wherein receiving the one or more contact inputs includes receiving a tapping input on a region of the touchpad, and receiving a sliding input on the region of the touchpad.

17. The system of claim 14, wherein means for receiving the one or more inputs includes receiving the one or more motion inputs as detected by an accelerometer.

18. The system of claim 14, further comprising:
means for determining an input mode of the portable device;
means for receiving a change input operable to toggle between a plurality of input devices that detects the one or more inputs.

19. The system of claim 18, wherein the input mode of the portable device includes a contact mode and a motion mode.

20. A computer readable medium including logic for interacting with a portable device, the logic operable to perform the following steps:
receive one or more inputs, wherein the one or more inputs is one or more contact inputs or one or more motion inputs;
generate one or more virtual keys based on the one or more inputs received;
associate the one or more virtual keys with a command of a displayable component;
interpret the command of the displayable component in accordance with an application;
display the displayable component of the application, wherein displaying is perpendicular to the one or more contact inputs.

21. The computer readable medium of claim 20, wherein receiving the one or more inputs includes receiving the one or more contact inputs on a touchpad.

22. The computer readable medium of claim 21, wherein receiving the one or more contact inputs includes receiving a tapping input on a region of the touchpad, and receiving a sliding input on the region of the touchpad.

23. The computer readable medium of claim 20, wherein receiving the one or more inputs includes receiving the one or more motion inputs as detected by an accelerometer.

24. The computer readable medium of claim 20, the logic further operable to:
determine an input mode of the portable device;
receive a change input operable to toggle between a plurality of input devices that detects the one or more inputs.

25. The computer readable medium of claim 24, wherein the input mode of the portable device includes a contact mode and a motion mode.
